(19) United States
(12) Patent Application Publication
(10) Pub. No.: US 2025/0256614 A1
(43) Pub. Date: Aug. 14, 2025

(54) VEHICLE

(71) Applicant: TOYOTA JIDOSHA KABUSHIKI KAISHA, Toyota-shi (JP)

(72) Inventor: Shinji ICHIKAWA, Nagoya-shi (JP)

(73) Assignee: TOYOTA JIDOSHA KABUSHIKI KAISHA, Toyota-shi (JP)

(21) Appl. No.: 19/019,516

(22) Filed: Jan. 14, 2025

(30) Foreign Application Priority Data
Feb. 14, 2024 (JP) 2024-020155

(51) Int. Cl. B60L 53/80; B60L 3/00

(52) U.S. Cl. CPC B60L 53/80; B60L 3/0046

(57) ABSTRACT

ECU performs a process including the steps of acquiring a resistance value of an insulation resistance, determining that a battery pack having a resistance value equal to or less than a threshold value has an electric leakage, turning on the respective SMR when the resistance value is greater than the threshold value, acquiring a resistance value of the insulation resistance, and determining that an electric leakage occurs in the vehicle body when the resistance value is equal to or less than the threshold value.

### CROSS-REFERENCE TO RELATED APPLICATION

This application claims priority to Japanese Patent Application No. 2024-020155 filed on Feb. 14, 2024, incorporated herein by reference in its entirety.

### BACKGROUND

### 1. Technical Field

The present disclosure relates to a vehicle including a detachable battery.

### 2. Description of Related Art

Japanese Unexamined Patent Application Publication (Translation of PCT Application) No. 2020-523576 (JP 2020-523576 A) discloses an electric leakage detection device for detecting an electric leakage using an insulation resistance value indicating an insulation state between a battery and a ground.

### SUMMARY

In the above electric leakage detection device, however, a vehicle including a detachable battery is not assumed. Therefore, electric leakage detection according to the attached or detached state of the battery is not assumed. There is a possibility that appropriate electric leakage detection cannot be performed.

The present disclosure has been made to solve the above problem, and an object thereof is to provide a vehicle that includes a detachable battery and performs appropriate electric leakage detection.

A vehicle according to an aspect of the present disclosure includes:
a vehicle body;
a battery detachable from the vehicle body; and
a detection device provided to the battery and configured to detect whether an electric leakage has occurred.

The detection device is configured to detect whether the electric leakage has occurred in at least one of a conductive state in which the battery and an electric circuit of the vehicle body are connected and a disconnected state in which the battery and the electric circuit are disconnected.

In this way, whether the electric leakage has occurred is detected when the battery and the electric circuit on the vehicle body side are in the conductive state or the disconnected state. Accordingly, it is possible to accurately determine whether the electric leakage is caused by the electric circuit on the vehicle body side or by the battery.

In one embodiment, the detection device may be configured to detect whether the electric leakage of the battery has occurred in the disconnected state and, when the electric leakage is not detected, detect whether the electric leakage has occurred in the conductive state.

In this way, whether the electric leakage of the battery has occurred can be detected in the disconnected state. When the electric leakage of the battery is not detected, whether the electric leakage of the electric circuit on the vehicle body side has occurred can be detected in the conductive state.

In a further embodiment, the vehicle body may be configured such that a plurality of the batteries is mountable. In a conductive state in which each of the batteries and the electric circuit are connected, any one of a plurality of the detection devices may detect whether the electric leakage has occurred.

In this way, the occurrence of interference of the electric leakage detection among the detection devices is suppressed. Thus, it is possible to detect the electric leakage with high accuracy.

In a further embodiment, the vehicle body may be configured such that a plurality of the batteries is mountable. In a disconnected state in which each of the batteries and the electric circuit are disconnected, each of the detection devices of the batteries may detect whether the electric leakage has occurred.

In this way, it is possible to accurately determine whether the electric leakage has occurred in each of the batteries.

According to the present disclosure, it is possible to provide the vehicle that includes the detachable battery and performs appropriate electric leakage detection.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle according to the present embodiment;

FIG. 2 is a diagram illustrating an example of a configuration of a battery replacement system for replacing a battery pack;

FIG. 3 is a flowchart illustrating an example of a method of replacing a battery pack;

FIG. 4 is a flowchart illustrating an example of the electric leakage determination process of FIG. 3;

FIG. 5 is a diagram illustrating a first example of a configuration of a vehicle according to a modification;

FIG. 6 is a flowchart illustrating an example of the electric leakage determination process according to the modification;

FIG. 7 is a diagram illustrating a second example of a configuration of a vehicle according to a modification;

FIG. 8 is a diagram illustrating a third example of a configuration of a vehicle according to a modification;

FIG. 9 is a diagram illustrating a fourth example of a configuration of vehicles according to a modification; and

FIG. 10 is a diagram illustrating a fifth example of a configuration of a vehicle according to a modification.

### DETAILED DESCRIPTION OF EMBODIMENTS

Hereinafter, an embodiment of the present disclosure will be described in detail with reference to the drawings. It should be noted that the same or corresponding parts in the drawings are designated by the same reference characters and repetitive description will be omitted.

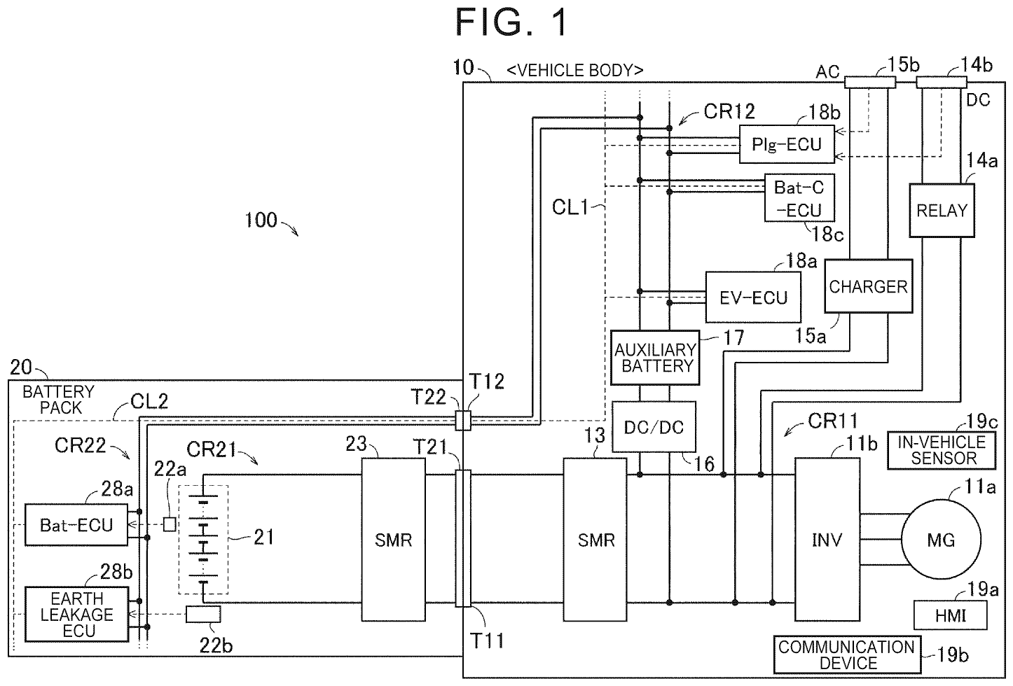

FIG. 1 is a diagram illustrating an example of a configuration of a vehicle according to the present embodiment. Referring to FIG. 1, a vehicle 100 includes a vehicle body 10 and a battery pack 20. The vehicle body 10 is a portion of the vehicle 100 other than the battery pack 20. The vehicle body 10 includes a vehicle driving device serving as a driving source. Vehicle-driven devices include MG (Motor Generator) 11a and inverters 11b. The vehicle driving device is configured to drive the vehicle 100 using the electric power output from the battery pack 20. The battery-pack 20 is configured to be connectable to an inverter 11b. The vehicles 100 are, for example, battery electric vehicle that do not include an internal combustion engine. However, the present disclosure is not limited thereto, and the vehicles 100 may be plug-in hybrid electric vehicle including an internal combustion engine or other electrified vehicle.

The vehicle body 10 includes a circuit CR11 and a CR12. The battery-pack 20 includes a circuit CR21 and a CR22. The circuit CR12 includes an auxiliary battery 17. The circuit CR21 includes a battery 21. The battery 21 is, for example, a secondary battery such as a lithium ion battery, a nickel metal hydride battery, or a sodium ion battery. The type of the secondary battery may be a liquid secondary battery or an all-solid secondary battery. A plurality of secondary batteries may form a battery pack. The auxiliary battery 17 corresponds to a low-voltage power supply that outputs power at a voltage lower than the voltage of the battery 21. A DC/DC converter 16 is provided between the circuit CR11 and the circuit CR12.

The circuit CR11 in the vehicle body 10 includes a MG11a, an inverter 11b, a DC charge relay 14a, a DC inlet 14b, a AC charger 15a, and a AC inlet 15b. The circuit CR21 in the battery pack 20 is provided with a BMS (Battery Management System) 22a and an electric leakage detector 22b.

The vehicle body 10 further includes a terminal T11 to which the battery pack 20 can be attached and a SMR (System Main Relay) 13 disposed between the terminal T11 and the vehicle driving device (inverter 11b). The circuit CR11 (high-voltage power supply line) is connected to the terminal T11 via an SMR 13. The battery-pack 20 includes a terminal T21 to which the vehicle body 10 is attachable and detachable, and an SMR 23 disposed between the terminal T21 and the circuit CR21. The circuit CR21 (high-voltage power supply line) is connected to the terminal T21 via an SMR 23.

The terminal T21 of the battery pack 20 is connected to the terminal T11 of the vehicle body 10. SMR 23 of the battery pack 20 is disposed between the terminal T21 of the battery pack 20 and the battery 21. SMR 23 enables the connection/disconnection between the target device (inverter 11b) and the battery 21 to be easily and appropriately switched.

The vehicle body 10 further includes a terminal T12 to which the battery pack 20 can be attached and detached. Circuit CR12 (low-voltage power supply line) in the vehicle body 10 is connected to the terminal T12. A communication line CL1 (a broken line in FIG. 1) in the vehicle body 10 is also connected to the terminal T12. The battery-pack 20 further includes a terminal T22. In the battery-pack 20, the circuit CR22 (low-voltage power supply line) and the communication line CL2 (broken line in FIG. 1) are connected to the terminal T22.

The auxiliary battery 17 supplies electric power for driving auxiliary machines mounted on the vehicle 100. The auxiliary battery 17 outputs DC power to the circuit CR12 (low-voltage power supply line). The circuit CR12 further includes ECUs 18a, 18b, 18c in addition to the auxiliary battery 17. The circuit CR22 further includes ECUs 28a, 28b. The auxiliary battery 17 supplies power to each of 18c, 28a, 28b from, for example, a ECU18a connected to the low-voltage power supply line. “ECU” means an electronic control unit (Electronic Control Unit).

ECU18a corresponds to a control device (EV-ECU) that controls various types of control related to the vehicles 100. ECU18b corresponds to a control device (Plg-ECU) that detects the status of each of DC inlet 14b and AC inlet 15b. ECU18c corresponds to a control device (Bat-C-ECU) that controls DC charge-relay 14a and AC charger 15a. ECU28a corresponds to a control device (Bat-ECU) that monitors the status of the batteries 21 and controls SMR 23. ECU28b corresponds to a control device (earth leakage ECU) that monitors the earth leakage status of the circuit CR21. For example, ECU28b detects a current between the electric circuit including the circuit CR21 and the grounding, calculates a resistance value of the insulation resistance using the detected current, and calculates the calculated resistance value as a leakage condition.

ECU includes a processor and a storage device. The storage device is configured to be able to save the stored information. In addition to the program, the storage device stores various kinds of information used in the program. In this embodiment, various kinds of control are executed by the processor executing a program stored in the storage device. However, these processes may be executed only by hardware (electronic circuit) without using software.

In the vehicle 100, ECU are communicably connected to each other via an in-vehicle network (e.g., a CAN (Controller Area Network)). ECU18a obtains information from other ECU, controls the inverter 11b, DC/DC converters 16 and SMRs 13, 23, and sends control commands to ECU18c and ECU28a.

BMS22a detects the condition (current, voltage, temperature, etc.) of the battery 21, and outputs the detected condition to ECU28a. The electric leakage detector 22b detects a leakage condition (for example, an insulating resistor) of the circuit CR21, and outputs the detected condition to ECU28b. ECU18a acquires information (state information) indicating a battery state and an electric leakage state from ECUs 28a, 28b.

DC/DC converters 16 transform DC power between the circuit CR11 and the circuit CR12. Specifically, DC/DC converters 16 step down the DC power from the batteries 21, and provide the DC power to the auxiliary battery 17 and other auxiliary devices connected to the circuit CR12. The capacity of the battery 21 is larger than the capacity of the auxiliary battery 17.

When the terminal T21, T22 of the battery pack 20 is connected to the terminal T11, T12, the battery pack 20 is attached to the vehicle body 10, thereby forming the vehicle 100. In the vehicle 100, a communication line CL1 of the vehicle body 10 and a communication line CL2 of the battery pack 20 are connected. These communication lines constitute an in-vehicle network (e.g., a CAN) of the vehicle 100.

MG11a functions as a driving motor. The inverter 11b functions as a PCU (Power Control Unit) for MG11a. The inverter 11b drives MG11a using the electric power supplied from the battery 21 of the battery pack 20. MG11a converts power to torques and rotates the drive wheels of the vehicles 100. In addition, MG11a performs regenerative power generation at the time of deceleration of the vehicles 100, for example, and charges the batteries 21.

Each of DC inlet 14b and AC inlet 15b has a terminal for detecting connection/disconnection of the charging cable (plug), and outputs a signal indicating whether or not the charging cable is connected to ECU18b. ECU18a acquires information indicating the inlet state from ECU18b, and transmits a control command to ECU18c. AC charger 15a performs AC/DC transformation. The plug-in charge of the batteries 21 is executed from ECU18a in cooperation with 18c.

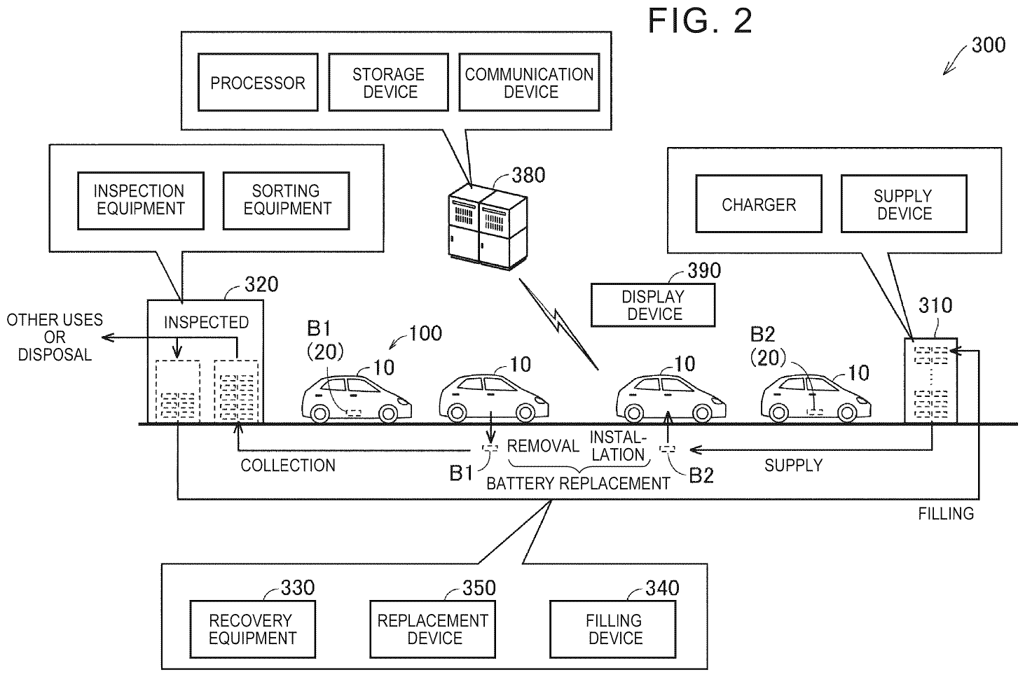

The vehicle body 10 further includes a HMI (Human Machine Interface) 19a and a communication device 19b. HMI19a and the communication device 19b are also supplied with electric power from the auxiliary battery 17. HMI19a includes an input device and a display device provided in the vehicle cabin. HMI19a may include a touch panel display. The input device outputs a signal corresponding to an input from the user to ECU18a. The communication device 19b is configured to be capable of wirelessly communicating with servers 380 (FIG. 2) described later. In addition, various sensors (typically referred to as in-vehicle sensor 19c) that are not illustrated are also mounted on the vehicle body 10. ECU18a is configured to acquire the detections of these sensors, either directly or via other ECU.

In this embodiment, HMI19a includes an activation switch. The user of the vehicle 100 can activate or deactivate the control system (including each ECU) of the vehicle 100 or turn the vehicle 100 Ready-ON or Ready-OFF by operating the activation switch.

Ready-ON state is a state in which the voltage of the battery 21 of the battery pack 20 connected to the vehicle body 10 is applied to the circuit CR11 of the vehicle body 10. In Ready-ON state, SMR 13 is in the closed state, SMR 23 of the battery pack 20 is also in the closed state, and electric power is supplied from the battery 21 corresponding to the closed state SMR 23 to the vehicle driving device (MG11a and inverter 11b). Ready-OFF state is a state in which the voltage of the battery 21 is not applied to the circuit CR11. In Ready-OFF state, SMR 13 is in the open state, and no electric power is supplied from the battery 21 of the battery pack 20 to the vehicle-driven device.

The battery pack 20 mounted on the vehicle 100 can be replaced with another battery pack. FIG. 2 is a diagram illustrating an example of a configuration of a battery replacement system for replacing a battery pack. The battery replacement system 300 illustrated in FIG. 2 is mounted in, for example, a battery replacement station.

Referring to FIG. 2, the battery replacement system 300 is configured to remove a battery pack mounted on the vehicle 100 from the vehicle body 10 and attach another battery pack to the vehicle body 10.

Hereinafter, the battery pack collected from the vehicle 100 is referred to as a “battery pack B1”, and the battery pack attached to the vehicle 100 instead of the battery pack B1 is referred to as a “battery pack B2”. Each of the battery packs B1, B2 has the configuration of the battery pack shown in FIG. 1. The battery pack B2 after being attached to the vehicle body 10 functions as the battery pack 20 (FIG. 1) in the vehicle 100.

Specifically, the battery replacement system 300 includes a first storage device 310, a second storage device 320, a recovery device 330, a filling device 340, a replacement device 350, a server 380, and a display device 390. The first storage device 310 stores a plurality of battery packs to be supplied to the vehicle. The first storage device 310 includes a charger and a supply device in addition to a pack storage unit (for example, a storage). The second storage device 320 stores a plurality of battery packs collected from a plurality of vehicles. The second storage device 320 includes an inspection device and a sorting device in addition to a pack storage unit (for example, a storage box). The server 380 includes a processor, a storage device, and a communication device, and functions as a control device. The storage device stores information (e.g., specification information) related to the respective battery packs present in the battery replacement system 300 separately by the identification information (pack ID) of the battery packs. The display device 390 displays information in accordance with an instruction from the server 380.

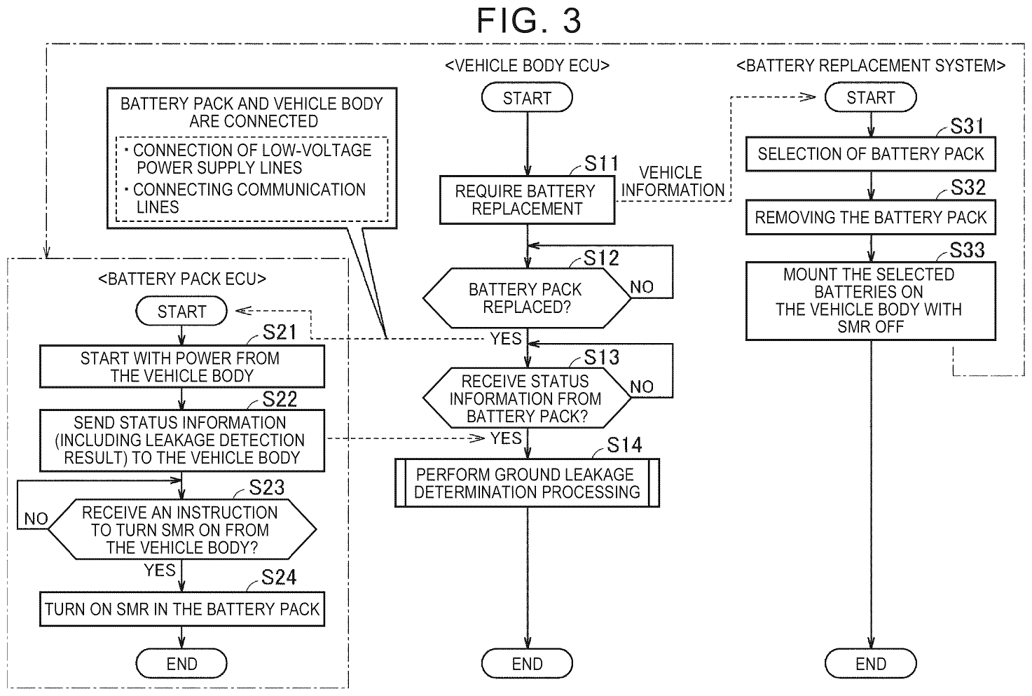

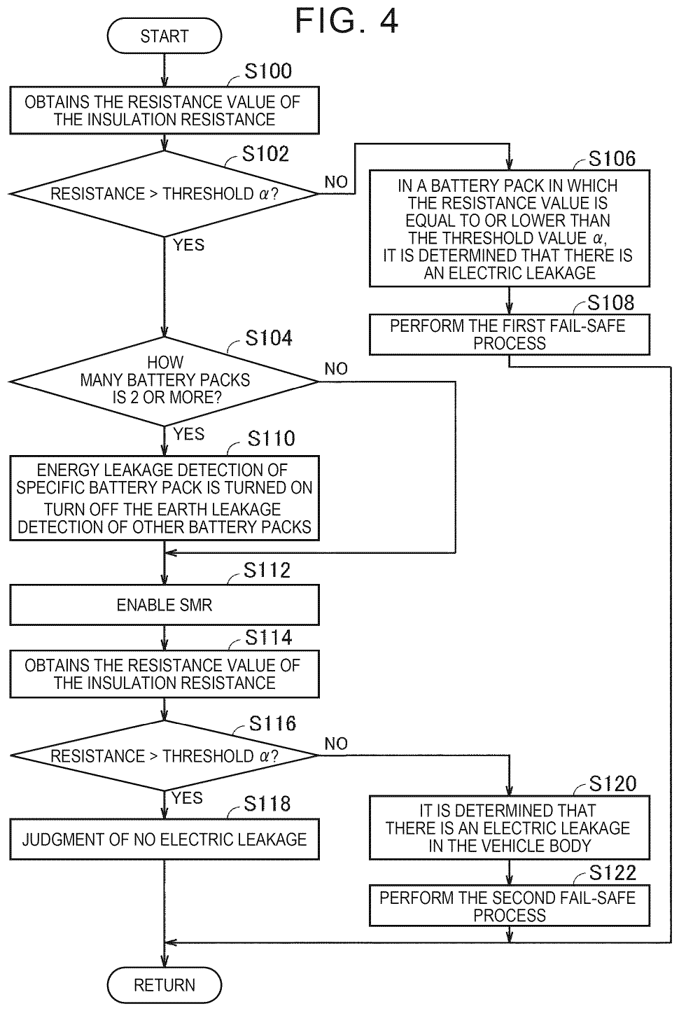

Hereinafter, a battery replacement method will be described with reference to FIGS. 1 to 4. FIG. 3 is a flowchart illustrating an example of a method of replacing a battery pack. FIG. 4 is a flowchart illustrating an example of the electric leakage determination process illustrated in FIG. 3. For example, after the vehicles 100 are parked in a predetermined area in the battery-replacing station, ECU18a starts S14 process from S10 shown in FIG. 3. ECU18a may initiate the process flow in response to a request from a terminal (user terminal) of the user of the vehicle 100 or a request from an inputting device in the vehicle 100. ECU18a and servers 380 are configured to be wirelessly communicable.

In step (hereinafter, step is referred to as “S”) 11, ECU18a transmits a signal requesting replacement of the battery pack (hereinafter, referred to as “replacement request signal”) to the servers 380. The replacement request signal includes identification information (vehicle ID) of the vehicle 100 and specification information of respective battery packs (battery pack B1) mounted on the vehicle 100. The replacement request signal may include the specification information of the vehicle body 10 in place of or in addition to the specification information of the battery-pack B1.

In S12, ECU18a determines whether or not the battery pack 20 has been replaced. The determination of S12 is repeated until the replacement of the battery-pack 20 is completed (NO in S12).

Upon receiving the exchange-request signal, the server 380 starts S33 process from S31 of FIG. 3.

In S31, the server 380 selects a battery pack that matches the specification of the vehicle 100 (the battery pack B1 or the specification of the vehicle body 10) indicated by the replacement request signal from among the battery packs (stocks) held by the first storage device 310. If it is determined that there is no battery pack in stock that matches the specifications of the vehicle 100, the server 380 may cause the display device 390 to display a message for explanation of the situation, and stop the battery replacement process. If S31 selects a battery pack, the process is transferred to S32.

In S32, the servers 380 control the replacement device 350 so that the battery-pack B1 is removed from the vehicle body 10. Accordingly, the vehicle body 10 and the battery-pack B1 are separated from each other. The process is then transferred to a S33.

In S33, the servers 380 control the charger of the first storage device 310 so that the battery-pack B2 selected by S31 is charged. However, the charging timing can be changed as appropriate. The charged battery pack may be filled in the first storage device 310. When the charging is completed, the server 380 controls the supply device of the first storage device 310 so that the battery-pack B2 is conveyed (supplied) from the first storage device 310 to the replacement device 350. Subsequently, the servers 380 control the replacement device 350 so that the battery-pack B2 is attached to the vehicle body 10. At this time, SMR 23 of the attached battery-pack B2 is opened. Thereafter, the server 380 transmits a signal indicating completion of the installation of the battery pack (hereinafter, referred to as a “replacement completion signal”) to ECU18a.

FIG. 2 illustrates an example in which removal of the battery pack and attachment of the battery pack are performed at different positions. The vehicle position may be adjusted prior to removal of the battery pack, prior to installation of the battery pack, or both. A conveyance device (for example, a conveyance device of a conveyor type) or a conveyance robot (not shown) may move the vehicle. However, the removal of the battery pack and the attachment of the battery pack may be performed at the same position. The battery pack may be replaced (removed and attached) while the vehicle is stationary. The transport method of each of the recovery device 330, the supply device, and the filling device 340 is also arbitrary. These conveyance methods may be a conveyor method or a method using a conveyance robot. Note that the battery pack (power storage device) may be manually replaced by the user without communication between the battery replacement system (station) and the vehicle.

For example, when the battery pack B2 is attached to the vehicle body 10, the terminal T11, T12 of the battery pack B2 is connected to the terminal T21, T22 of the vehicle body 10. As a result, the vehicle body 10 and the battery pack B2 are connected to each other as shown in FIG. 1. By attaching the battery pack B2 to the vehicle body 10, a low-voltage power supply line (circuits CR12, CR22) and a communication line (communication lines CL1, CL2) are connected between the vehicle body 10 and the battery pack B2. Then, in the battery-pack B2, S24 process is started from S21 shown in FIG. 3.

In S21, ECU28a is activated by electric power supplied from a power source (auxiliary battery 17) in the vehicle body 10. The process is then transferred to a S22.

In S22, ECU28a transmits information indicating the state of the battery pack (hereinafter, referred to as “state information”) to ECU18a. The status information includes, for example, information about the present-day voltage of the battery 21 detected by BMS22a. Note that the state information may include information about the leakage detection result (leakage state) detected by the electric leakage detector 22b and the leakage ECU28b. The voltage of the battery 21 may vary depending on SOC (State of Charge) of the battery 21. SOC represents, for example, a ratio of the present amount of stored electricity to the amount of stored electricity in a fully charged state, from 0 to 100%. The process is then transferred to a S23.

In S23, ECU28a determines whether or not a SMR on-command has been received from the vehicle body 10. ECU28a waits for a SMR on-command from the vehicle body 10 in S23 while keeping SMR 23 open. When ECU28a receives SMR on-command (YES in S23), the process proceeds to S24.

In S24, ECU28a switches SMR 23 from the open state (shut-off state) to the closed state (connected state).

On the other hand, when the battery-pack B2 is attached to the vehicle body 10, ECU18a receives a replacement completion signal (S33) from the servers 380. Accordingly, when it is determined that S12 is YES, the process proceeds to S13.

In S13, ECU18a determines whether the status data is received from ECU28a of the battery-pack B2. When ECU18a receives the status information from the battery pack (YES in S13), the process is transferred to S14.

In S14, ECU18a executes the electric leakage determination process. Hereinafter, the leakage determination process will be described with reference to the flowchart of FIG. 4.

In S100, ECU18a acquires the resistance of the insulating resistance. For example, ECU18a may acquire the resistance value of the insulation resistance from the status information received from the battery pack 20 or may acquire the resistance value of the insulation resistance from ECU28b. When a plurality of battery packs is mounted, ECU18a may acquire the resistance of the insulation resistance corresponding to each battery pack from each battery pack. The process is then transferred to a S102.

In S102, ECU18a determines whether or not the resistance value of the insulating resistance obtained by S100 is larger than the threshold value a. The threshold value a is a predetermined value for determining the presence or absence of an electric leakage, and is adapted by an experiment or the like. When a plurality of battery packs is mounted, ECU18a determines whether or not the resistivity of the insulating resistances of the battery packs is greater than the threshold value α. When it is determined that the resistance value of the insulation resistance is larger than the threshold value α (YES in S102), the process proceeds to S104.

In S104, ECU18a determines whether or not the number of battery-packs mounted on the vehicle 100 is two or more. For example, ECU18a determines whether or not the number of battery packs installed in the vehicles 100 is two or more by using the number of pack ID received from the battery pack, the number of attached battery packs received from the servers 380, and the like. The process is then transferred to a S110. If it is determined in S102 that the resistance value of the insulating resistance is equal to or less than the threshold value α (NO in S102), the process proceeds to S106.

In S106, ECU18a determines that there is an electric leakage in the battery pack in which the resistance value of the insulation resistance is equal to or less than the threshold value α. ECU18a sets, for example, a flag associated with the pack ID of the battery pack in which the resistance value of the insulation resistance is equal to or less than the threshold value a to the ON-state. The process is then transferred to a S108.

In S108, ECU18a performs a first fail-safe process. The first fail-safe process may include at least one of a process of controlling SMR 23 of the battery pack of the pack ID corresponding to the flag of the ON state to the OFF state, a process of prohibiting the switching of SMR 23 of the battery pack to the ON state, a process of controlling SMR 13 to the OFF state, and a process of prohibiting the switching of SMR 13 to the ON state. The process is then terminated.

In S110, ECU18a sets the electric leakage detection of any one of the plurality of battery packs (hereinafter, referred to as a “specified battery pack”) to the ON state, and sets the electric leakage detection of the other battery packs to the OFF state. More specifically, ECU18a is configured to detect an electric leakage by turning on a circuit for detecting a resistance of an insulation resistance of any one of the battery packs. ECU18a may be configured to detect an electric leakage by switching off a circuit for detecting a resistance value of an insulation resistance of another battery pack. The process is then transferred to a S112. If it is determined that the number of batteries is less than two (NO in S104), the process proceeds to S112.

In S112, ECU18a sets SMR to the on-state. ECU18a transmits a SMR on-command to SMR 13 and SMR 23 of the battery pack 20 (SMR 23 of all the battery packs when a plurality of battery packs 20 are mounted). The process is then transferred to a S114.

In S114, ECU18a acquires the resistance of the insulating resistance. When a plurality of battery packs 20 are mounted, the resistance value of the insulation resistance is acquired from the specific battery pack. The process is then transferred to a S116.

In S116, ECU18a determines whether or not the resistance value of the insulating resistor is greater than a threshold value α. Since the threshold value α is as described above, the detailed description thereof will not be repeated. When it is determined that the resistance value of the insulation resistance is larger than the threshold value α (YES in S116), the process proceeds to S118.

In S118, ECU18a determines that there is no electric leakage. The process is then terminated. For example, ECU18a sets a flag indicating that there is no electric leakage on both the vehicle body side and the battery pack side to the ON-state. ECU18a may allow the transition to Ready-ON condition provided that the flag indicating no leakage is in the on-state. If it is determined that the resistance value of the insulating resistance is equal to or less than the threshold value a (NO in S116), the process proceeds to S120.

In S120, ECU18a determines that there is an electric leakage in the vehicle body 10. For example, ECU18a sets a flag indicating that there is an electric leakage in the vehicle body 10 to an on-state. The process is then transferred to a S122.

In S122, ECU18a performs a second fail-safe process. The second fail-safe process may include a process of controlling SMR 13 to be in the off-state, a process of prohibiting SMR 13 from being switched to the on-state, and the like. The second fail-safe process may include a process of controlling SMR 23 of the battery pack (all the battery packs when a plurality of battery packs is mounted) to the off-state, a process of prohibiting the switching of SMR 23 of the battery pack to the on-state, and the like. The process is then terminated.

As described above, according to the vehicle 100 of the present embodiment, it is possible to identify the cause of the electric leakage while detecting the presence or absence of the electric leakage using the detection result of whether or not the resistance value of the insulation resistance in a state in which the battery and the electric circuit on the vehicle body 10 side are connected is lower than the threshold value, and the detection result of whether or not the resistance value of the insulation resistance in a state in which the battery and the electric circuit on the vehicle body 10 are disconnected is lower than the threshold value. Specifically, when an electric leakage is detected prior to turning on SMR 23 of the battery pack 20, it is possible to identify that the cause of the electric leakage is caused by the battery pack 20. In addition, when it is determined that there is no electric leakage in the battery pack and SMR 23 of the battery pack 20 is turned on and it is determined that there is an electric leakage, it is possible to specify that the electric leakage is caused by the vehicle body 10. Therefore, it is possible to provide a vehicle that performs appropriate electric leakage detection in a vehicle equipped with a detachable battery.

Modification examples will be described below.

In the above-described embodiment, the flowchart of FIG. 4 has been described as including processing assuming a case where a plurality of battery packs 20 are mounted. However, when the vehicle 100 is a vehicle in which the upper limit number of the battery packs 20 is one as illustrated in FIG. 1, S104 process and S110 process in the flow chart of FIG. 4 may be omitted.

Further, in the above-described embodiment, the case where one battery pack 20 is mounted on the vehicle 100 has been described as an example, but a plurality of battery packs 20 may be mounted on the vehicle 100. In this case, an SMR 23 for connecting and disconnecting the electric circuit of the vehicle body 10 is provided in each of the plurality of battery-packs 20. ECU18a changes the combination of the on-state and the off-state of SMR 23 in the plurality of battery packs 20 to detect the presence or absence of an electric leakage for each battery.

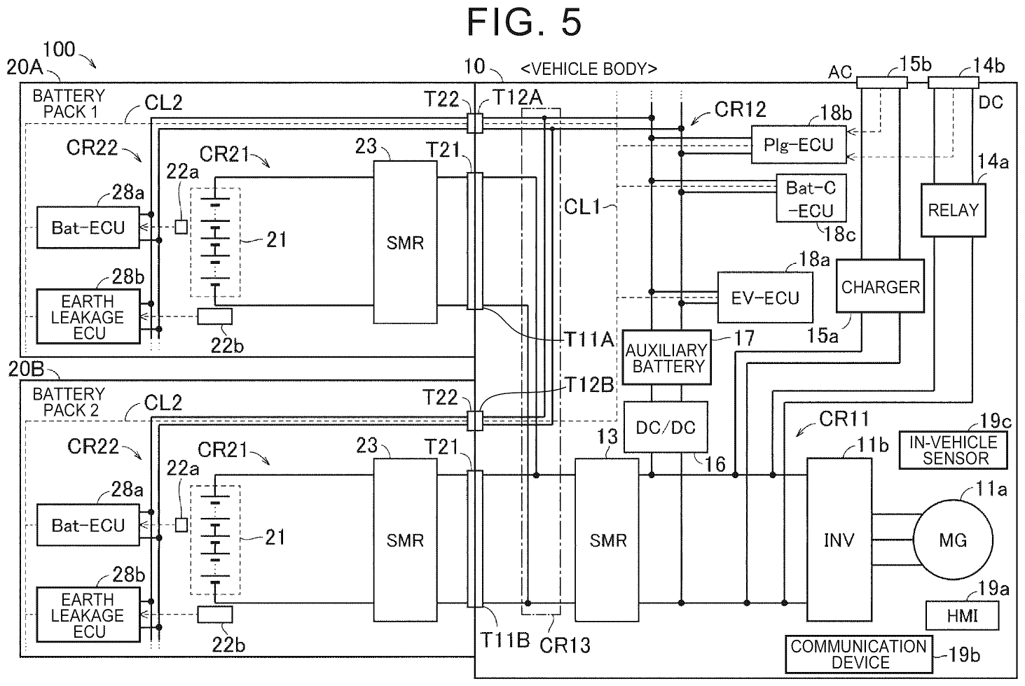

FIG. 5 is a diagram illustrating a first example of a configuration of a vehicle 100 according to a modification. The vehicle 100 illustrated in FIG. 5 differs from the vehicle 100 illustrated in FIG. 1 in that the battery pack 20 includes battery packs 20A, 20B and a parallel-circuit CR13 that connects the battery packs 20A, 20B to SMR 13 in parallel. The battery packs 20A, 20B have the same configuration as that of the battery pack 20. Therefore, the detailed description thereof will not be repeated.

In such a configuration, when the electric leakage determination process illustrated in FIG. 4 is executed, ECU18a acquires (S100) the resistance of the insulating resistance from the respective battery packs. When the resistance value of the insulation resistance of any of the battery packs is equal to or less than the threshold value α (NO in S102), it is determined that there is an electric leakage in the battery pack (S106), and the first fail-safe process is executed (S108).

On the other hand, when the resistance value of the insulation resistance of the respective battery packs is larger than the threshold value α (YES in S102), since the number of battery packs is two or more (YES in S104), the electric leakage detection of the particular battery pack (for example, the battery pack 20A) is set to the on-state. Further, the electric leakage detection of the other battery pack (battery pack 20B) is set to the off-state (S110).

Thereafter, SMR 13, SMR 23 of the battery pack 20A, and SMR 23 of the battery pack 20B are turned on (S112), and the resistivity of the insulating resistor is acquired from the battery pack 20A (S114). When the obtained resistive value is larger than the threshold value a (YES in S116), it is determined that there is no electric leakage (S118). When the resistive value is equal to or less than the threshold value a, it is determined that there is an electric leakage in the vehicle body (S120), and the second fail-safe process is executed (S122).

Even in this manner, it is possible to detect the presence or absence of an electric leakage in the respective battery packs when SMR 13 is shut off in the vehicles on which the plurality of battery packs are mounted. Further, when no electric leakage is detected in the respective battery packs, it is possible to detect the presence or absence of an electric leakage in the electric circuit of the vehicle body 10 when SMR 13 is in conduction.

Further, when a plurality of batteries are mounted and SMR 23 of SMR 13 and the battery packs are set to the on-state, the electric leakage is detected only by the specified battery pack (battery pack 20A). Therefore, it is possible to detect the electric leakage with high accuracy because the electric leakage is suppressed from occurring with the electric leakage detection device of the other battery-pack 20B.

Further, in the above-described embodiment, when a plurality of batteries are mounted, the leakage detection of other battery packs other than the specific battery pack is set to the off state after the presence or absence of the leakage of each battery pack is first detected in the leakage determination process when the battery pack is replaced. However, for other battery packs, leakage may be detected at the time of Ready-OFF.

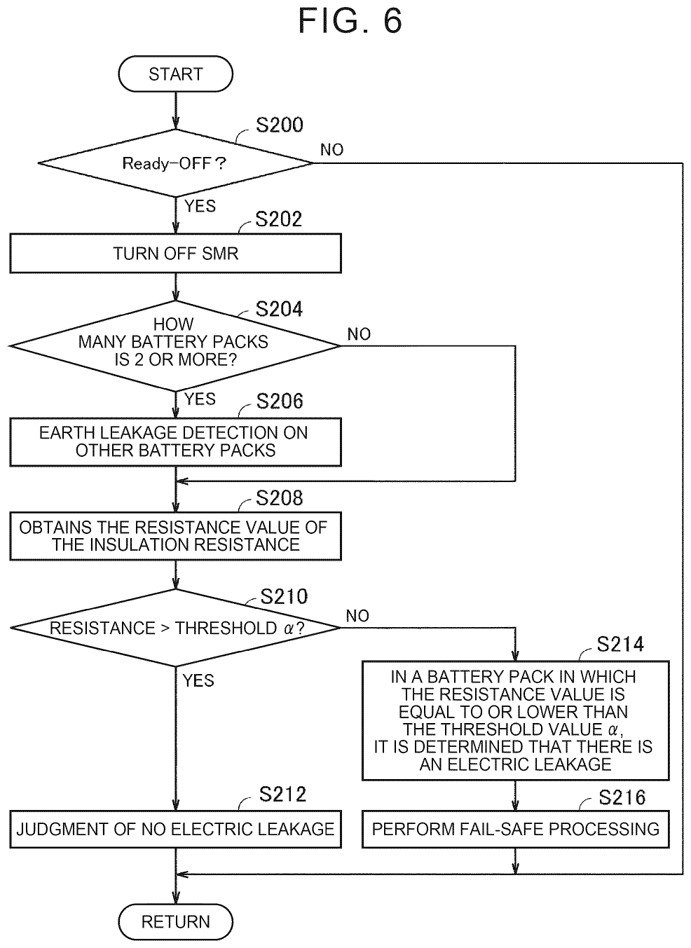

Hereinafter, the electric leakage determination process at the time of Ready-OFF will be described referring to FIG. 6. FIG. 6 is a flowchart illustrating an example of the electric leakage determination process according to the modification.

In S200, ECU18a determines whether or not it is at the time of Ready-OFF. ECU18a may determine that it is at the time of Ready-OFF after the operation (off operation) of the start switch is accepted at the time of Ready-ON and when the operation (on operation) of the start switch is not accepted thereafter. If it is determined that the time is Ready-OFF time (YES in S200), the process proceeds to S202.

In S202, ECU18a turns off SMR 23 of SMR 13 and the battery-packs 20A, 20B. The process is then transferred to a S204.

In S204, ECU18a determines whether or not the number of battery packs to be mounted is two or more. Since the method of determining the number of battery packs is as described above, the detailed description thereof will not be repeated. If it is determined that the number of mounted battery-packs is two or more (YES in S204), the process proceeds to S206.

In S206, ECU18a sets the electric leakage detection of another battery pack (battery pack 20B) to the on-state. The process is then transferred to a S208. If it is determined that the number of mounted battery-packs is not two or more (NO in S204), the process proceeds to S208.

In S208, ECU18a obtains an insulation resistance from the battery pack. When a plurality of battery packs is mounted, the insulation resistance is acquired from each battery pack in which the electric leakage detection is set to the ON state. The process is then transferred to a S210.

In S210, EUC18a determines whether or not the resistance value of the insulating resistor is greater than a threshold value α. When it is determined that the resistance value of the insulation resistance is larger than the threshold value α (YES in S210), the process is transferred to S212.

In S212, ECU18a determines that there is no electric leakage. The process is then terminated. If it is determined that the resistance value of the insulating resistance is equal to or less than the threshold value α (NO in S210), the process proceeds to S214.

In S214, ECU18a determines that there is an electric leakage in the battery pack in which the resistance value of the insulation resistance is equal to or less than the threshold value α. ECU18a sets, for example, a flag associated with the pack ID of the battery pack in which the resistance value of the insulation resistance is equal to or less than the threshold value α to the ON-state. The process is then transferred to a S214.

At S216, ECU18a performs a fail-safe process. The fail-safe process may include at least one of a process of controlling SMR 23 of the battery pack of the pack ID corresponding to the flag of the ON state to the OFF state, a process of prohibiting the switching of SMR 23 of the battery pack to the ON state, a process of controlling SMR 13 to the OFF state, and a process of prohibiting the switching of SMR 13 to the ON state. The process is then terminated.

With this configuration, it is possible to detect the presence or absence of an electric leakage in the respective battery packs when SMR 13 is shut off at the time of Ready-OFF in the vehicles on which the plurality of battery packs are mounted.

Further, the configuration of the vehicle body 10 illustrated in FIG. 1 or 5 can be changed as appropriate. For example, SMR 13 of the vehicle body 10 may be omitted, or SMR 23 of the battery-packs 20, 20A, 20B may be omitted. In addition, at least one of DC inlet 14b and AC inlet 15b may be omitted, or may be changed to one inlet shared by AC/DC. These inlets may be configured to be capable of bidirectional power transfer. The vehicle body may perform an external power supply (V2X: Vehicle to Everything) using the electric power outputted from the attached battery pack.

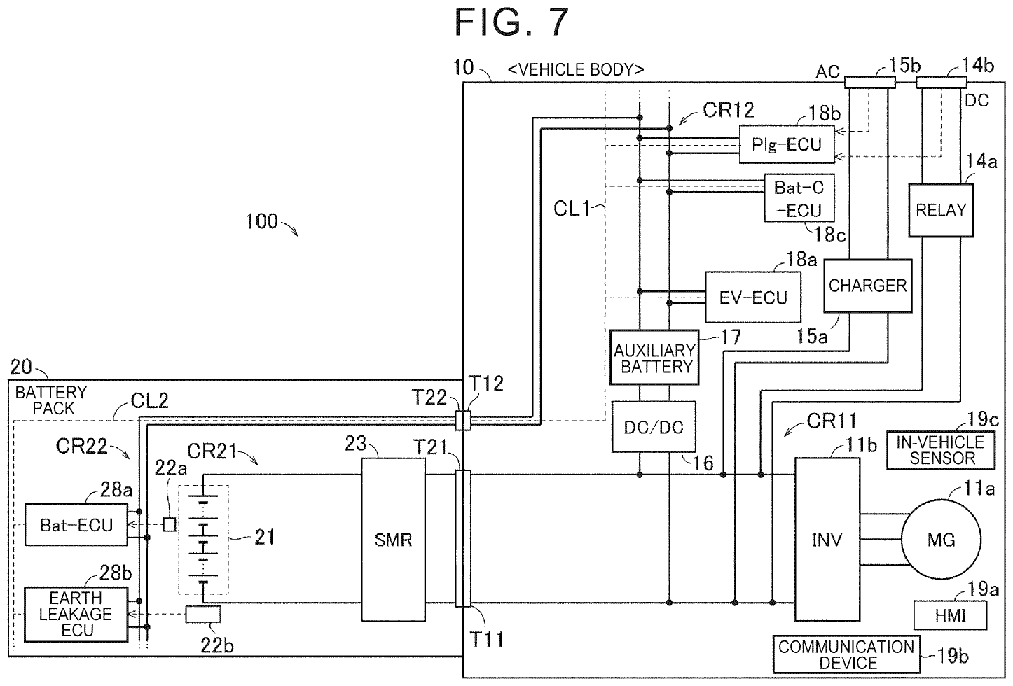

Specifically, the vehicle 100 may have the configuration shown in FIG. 7. FIG. 7 is a diagram illustrating a second example of a configuration of a vehicle 100 according to a modification. The vehicle body 10 shown in FIG. 7 differs from the vehicle body 10 shown in FIG. 1 in that it does not have a SMR 13. With regard to other configurations, the vehicle body 10 illustrated in FIG. 7 and the vehicle body 10 illustrated in FIG. 1 have the same configuration. Therefore, the detailed description thereof will not be repeated.

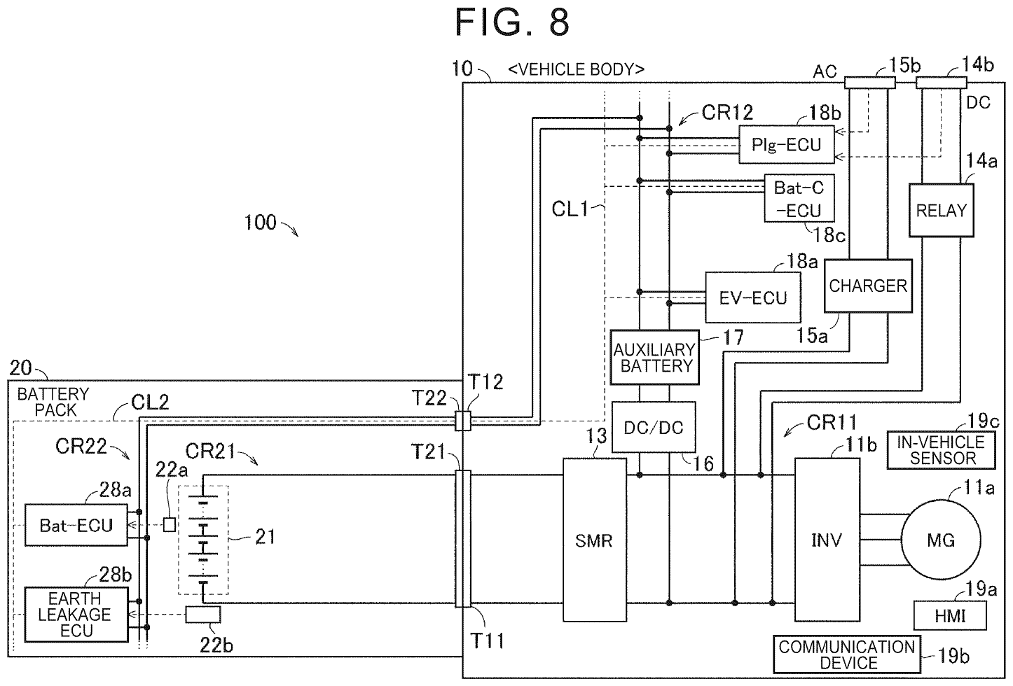

Further, the vehicle 100 may have the configuration shown in FIG. 8. FIG. 8 is a diagram illustrating a third example of a configuration of a vehicle 100 according to a modification. The vehicle body 10 shown in FIG. 8 differs from the vehicle body 10 shown in FIG. 1 in that it does not have an SMR 23. With regard to other configurations, the vehicle body 10 illustrated in FIG. 8 and the vehicle body 10 illustrated in FIG. 1 have the same configuration. Therefore, the detailed description thereof will not be repeated.

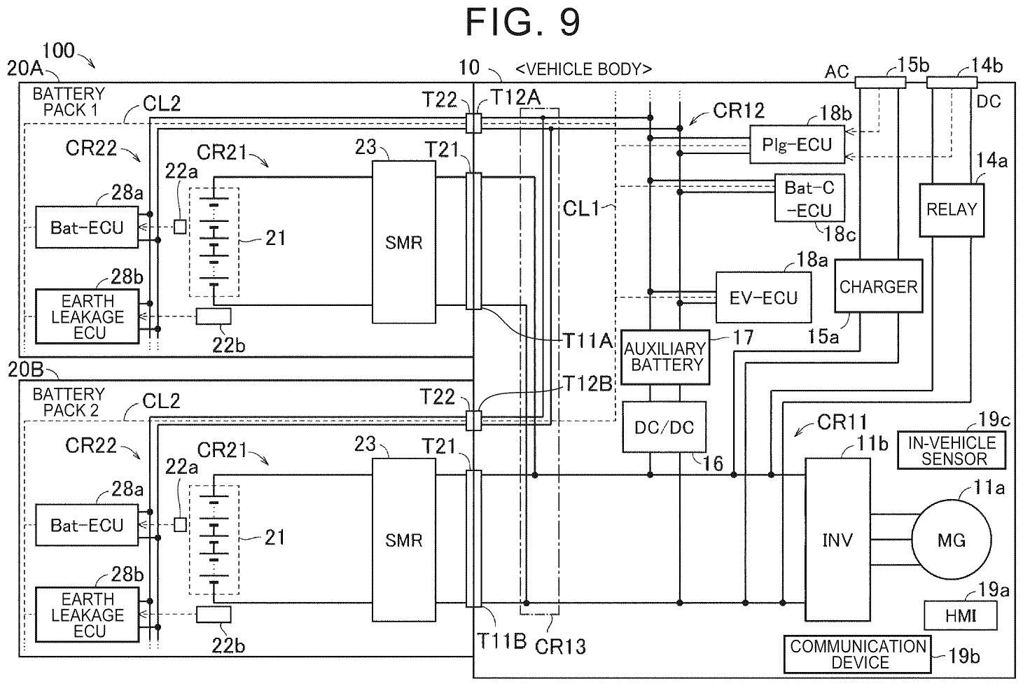

Further, the vehicle 100 may have the configuration shown in FIG. 9. FIG. 9 is a diagram illustrating a fourth example of a configuration of a vehicle 100 according to a modification. The vehicle body 10 shown in FIG. 9 differs from the vehicle body 10 shown in FIG. 5 in that it does not have a SMR 13. With regard to other configurations, the vehicle body 10 illustrated in FIG. 9 and the vehicle body 10 illustrated in FIG. 5 have the same configuration. Therefore, the detailed description thereof will not be repeated.

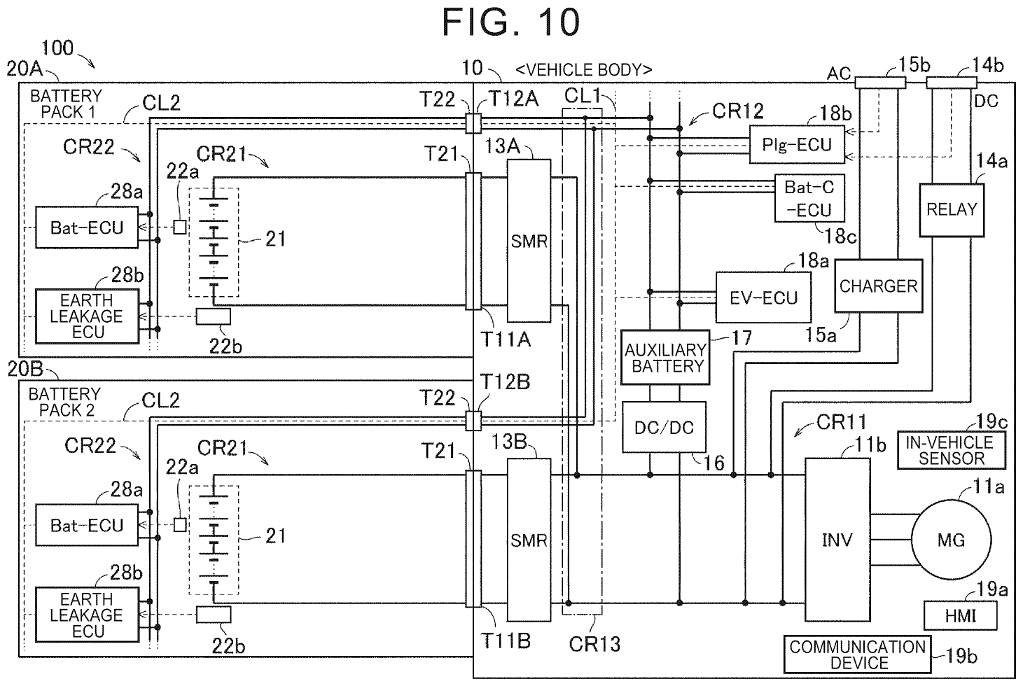

Further, the vehicle 100 may have the configuration shown in FIG. 10. FIG. 10 is a diagram illustrating a fifth example of a configuration of a vehicle 100 according to a modification. The vehicle body 10 shown in FIG. 9 differs from the vehicle body 10 shown in FIG. 5 in that it has SMRs 13A, 13B instead of SMRs 13, SMR 23. SMR 13A is provided in a power supply line connecting the terminal T11A and a branch point from a power supply line connecting the inverter 11b and the terminal T11B. SMR 13B is provided in a power supply line between the terminal T11B and the branch point. With regard to other configurations, the vehicle body 10 illustrated in FIG. 10 and the vehicle body 10 illustrated in FIG. 5 have the same configuration. Therefore, the detailed description thereof will not be repeated.

All or some of the above-mentioned modified examples may be combined for implementation.

It should be considered that the embodiments disclosed above are for illustrative purposes only and are not limitative of the disclosure in any aspect. The scope of the disclosure is represented by the appended claims, not by the above description, and includes all modifications within the meanings and scope equivalent to the claims.

What is claimed is:

1. A vehicle comprising:
a vehicle body;
a battery detachable from the vehicle body; and
a detection device provided to the battery and configured to detect whether an electric leakage has occurred, wherein
the detection device is configured to detect whether the electric leakage has occurred in at least one of a conductive state in which the battery and an electric circuit of the vehicle body are connected and a disconnected state in which the battery and the electric circuit are disconnected.

2. The vehicle according to claim 1, wherein the detection device is configured to detect whether the electric leakage of the battery has occurred in the disconnected state and, when the electric leakage is not detected, detect whether the electric leakage has occurred in the conductive state.

3. The vehicle according to claim 1, wherein:
the vehicle body is configured such that a plurality of the batteries is mountable; and
in a conductive state in which each of the batteries and the electric circuit are connected, any one of a plurality of the detection devices detects whether the electric leakage has occurred.

4. The vehicle according to claim 1, wherein:
the vehicle body is configured such that a plurality of the batteries is mountable; and
in a disconnected state in which each of the batteries and the electric circuit are disconnected, each of the detection devices of the batteries detects whether the electric leakage has occurred.
